(19) United States
(12) Patent Application Publication
(10) Pub. No.: US 2011/0297867 A1
(43) Pub. Date: Dec. 8, 2011

(54) FLOW GUIDED VALVE SEAT FOR STEAM TURBINE VALVES

(75) Inventors: Abhishek Chowdhury, Bangalore (IN); Vamshidhar Done, Bangalore (IN); Vishal Girishchandra Shah, Bangalore (IN); Hayagreeva Rao Karra Venkata, Kakinada (IN)

(73) Assignee: GENERAL ELECTRIC COMPANY, Schenectady, NY (US)

(21) Appl. No.: 12/794,988

(22) Filed: Jun. 7, 2010

(51) Int. Cl. F16K 1/42; F16K 51/00

(52) U.S. Cl. 251/333; 251/284

(57) ABSTRACT

A flow valve includes a control valve having a movable body, a stop valve having a movable body; and a valve seat having a facing surface that contacts at least a portion of one of the control valve body or the stop valve body when the flow valve is in a closed position, the facing surface of the valve seat being configured to merge with a rear portion of the valve seat at a tip portion, the facing surface of the valve seat having an aerodynamic profile that provides for a guided flow in a flow direction through the flow valve.

### BACKGROUND OF THE INVENTION

The subject matter disclosed herein relates to steam turbines and, in particular, to a steam turbine valve having a flow guided valve seat with an aerodynamic profile to improve the aerodynamic flow of steam through the valve.

A steam turbine commonly includes a steam turbine valve to control a flow rate of steam in the turbine. Depending on its location within the steam turbine, the valve may comprise a main stop and control valve or a combined reheat steam valve. In either case, the “flow” valve typically includes a movable valve body (e.g., linear motion) and a stationary valve seat, a portion of each coming together in contact to close the flow valve to prevent the flow of steam from the valve inlet from passing through the flow valve to the valve outlet, or that separate to open the flow valve to allow the flow of steam to pass through the flow valve from inlet to outlet.

In the operation of a steam turbine valve when allowing the flow of steam to pass through the valve, there may exist a relatively high pressure drop across the valve. This is due in part to the aerodynamic profile of the valve seat. This pressure drop across the valve may lead to an undesirable separation of the flow of steam downstream of the valve seat, particularly during movement of the valve body away from the valve seat. This flow separation can cause some degree of aerodynamic instability along with noise and vibration issues within the valve, and reduced overall steam turbine efficiency.

### BRIEF DESCRIPTION OF THE INVENTION

According to one aspect of the invention, a flow valve includes a control valve having a movable body, a stop valve having a movable body, and a valve seat having a facing surface that contacts at least a portion of one of the control valve body or the stop valve body when the flow valve is in a closed position, the facing surface of the valve seat being configured to merge with a rear portion of the valve seat at a tip portion, the facing surface of the valve seat having an aerodynamic profile that provides for a guided flow in a flow direction through the flow valve.

According to another aspect of the invention, a flow valve includes an inlet through which a flow of steam flows into the flow valve, an outlet through which the flow of steam exits the flow valve, and one of a control valve having a movable body or a stop valve having a movable body. The flow valve also includes a valve seat having a facing surface that contacts at least a portion of the one of the control valve body or the stop valve body when the flow valve is in a closed position, the facing surface of the valve seat being configured to merge with a rear portion of the valve seat at a tip portion, the facing surface of the valve seat having an aerodynamic profile that provides for a guided flow in a flow direction through the flow valve.

According to yet another aspect of the invention, a flow valve includes one of a control valve having a movable body or a stop valve having a movable body. The flow valve also includes a valve seat having a facing surface that contacts at least a portion of the one of the control valve body or the stop valve body when the flow valve is in a closed position, the facing surface of the valve seat being configured to merge with a rear portion of the valve seat at a tip portion, wherein the facing surface of the valve seat having an aerodynamic profile that provides for a guided flow in a flow direction through the flow valve.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a cross section view of a steam valve having a valve seat with a known aerodynamic profile;

FIG. 2 is a side view of the aerodynamic profile of a valve seat located within a steam valve according to an embodiment of the present invention;

FIG. 3 is a side view of the aerodynamic profile of a valve seat located within a steam valve according to another embodiment of the present invention; and

FIG. 4 is a side view of the aerodynamic profile of a valve seat located within a steam valve according to yet another embodiment of the present invention.

The detailed description explains embodiments of the invention, together with advantages and features, by way of example with reference to the drawings.

### DETAILED DESCRIPTION OF THE INVENTION

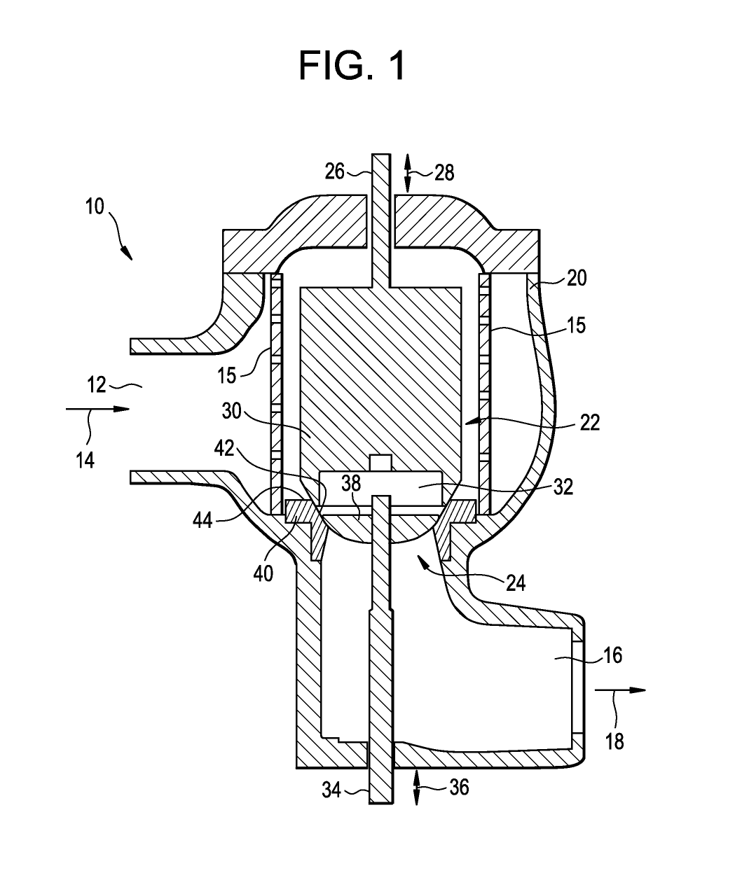

In FIG. 1 is a steam valve 10 that is part of a steam turbine. For example, the steam turbine valve 10 may be a combined main stop and control valve, a reheat valve, or other type of steam turbine valve (“flow valve”) that directs the flow of steam entering the flow valve 10 at an inlet 12 (e.g., a pipe), as indicated by a line with an arrowhead 14, then passing through openings in a strainer 15 inside the flow valve 10 and through the flow valve 10, and exiting out of an outlet 16 (e.g., a pipe) of the flow valve 10, as indicated by a line with an arrowhead 18, and on to further components of the steam turbine.

Also located within a casing 20 of the flow valve 10 are a control valve 22 and a stop valve 24. The control valve 22 may comprise a cylinder or rod 26 that is configured to be driven in a known manner (e.g., hydraulically, pneumatically, motor-driven, etc.) for, e.g., linear movement as indicated by a line with arrowheads 28. The control valve 22 also includes a valve body 30 located at one end of the rod 26 and connected or formed integral with the rod 26 for simultaneous motion of the control valve body 30 with movement of the rod 26. The control valve body 30 includes a cavity 32 formed in a lower portion of the control valve body 30.

The casing 20 also includes the stop valve 24 that may comprise a cylinder or rod 34, similarly configured as the rod 26 of the control valve 22 to be driven in a known manner (e.g., hydraulically, pneumatically, motor-driven, etc.) for, e.g., linear movement as indicated by a line with arrowheads 36. The stop valve 24 also includes a valve body 38 located at one end of the rod 34 and connected or formed integral with the rod 34 for simultaneous motion of the stop valve body 38 with movement of the rod 34. The stop valve body 38 may be moved into the cavity 32 of the control valve body 30.

Also shown in FIG. 1 is a valve seat 40 having a surface 42 with a relatively flat or linear aerodynamic profile. The valve seat 40 also includes a relatively flat portion 44 adjacent the flat surface 42. This flat portion 44 is also part of the aerodynamic profile of the valve seat 40. FIG. 1 shows both the control valve 22 and the stop valve 24 in a closed position. In such a position, a portion of both the control valve body 30 and the stop valve body 38 is in contact with the surface 42 of the valve seat 40, thereby closing off the flow of steam through the flow valve 10. That is, in the closed position shown in FIG. 1, the flow of steam is prevented from flowing from the valve inlet 12 to the valve outlet 16. However, in some instances of operation of the flow valve 10 only the control valve body 30 may contact the surface 42 of the valve seat 40, thereby closing off the flow of steam through the flow valve 10, or in other instances of operation of the flow valve 10 only the stop valve body 38 may contact the surface 42 of the valve seat 40, thereby closing off the flow of steam through the flow valve 10.

In contrast, in an open position of the flow valve 10 (not shown), the control valve 22 and the stop valve 24 are positioned such that their respective bodies 30, 38 are located away from the valve seat surface 42. In this position, the flow of steam is allowed to flow from the valve inlet 12 and pass through an opening or passageway formed between the control valve body 30 and the stop valve body 38 on one side of the opening, and the valve seat surface 42 on the other side of the opening, and then through to the steam valve outlet 16.

However, with this valve seat 40 in the open position, a portion of the flow of steam passing through the flow valve 10 strikes the flat surface 44 of the valve seat 40. This may cause an abrupt change in the flow direction of that portion of the flow of steam that strikes the flat surface 44 of the valve seat 40. In turn, the abrupt change in direction of the portion of the flow of steam can cause secondary flows and swirls in the flow of steam downstream of the flat surface 44 of the valve seat 40, and might result in relatively high pressure losses in the flow valve 10. That is, this flat surface 44 does not provide a guided flow of the steam through the flow valve 10, and instead presents an obstacle to the flow direction.

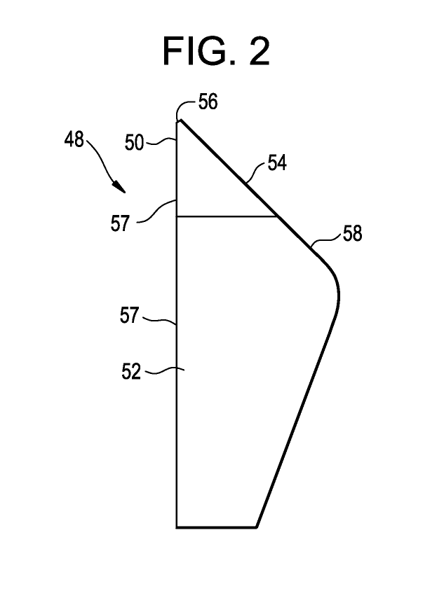

In FIG. 2 is a side view of the aerodynamic profile of a valve seat 48 located within the flow valve 10, according to an embodiment of the present invention. The valve seat 48 may comprise two pieces 50, 52 joined together, or may comprise a single piece. The aerodynamic profile of a surface 54 of the first piece 50 may be linear or straight at a certain angle in a flow direction with respect to a tip portion 56 of the first piece 50 of the valve seat 48. The tip portion 56 may be pointed. The surface 54 contacts a portion of the control valve body 30 and the stop valve body 38 when the flow valve 10 is in the closed position.

In contrast to the valve seat 40 of FIG. 1, there is no flat surface 44 in this embodiment of the valve seat 48 of FIG. 2. That is, the steam flow-facing surface 54 merges with a rear portion or surface 57 of the first piece 50 (and of the second piece 52 when utilized in an embodiment) at the tip portion 56, wherein the tip portion comprises a point that contains no flat portion. Further, the aerodynamic profile of a surface 58 of the second piece 52 of the valve seat 48 may also be linear or straight for at least a portion of its length, but may be at an angle with respect to the tip portion 56 of the first piece 50 that is less than the angle of the surface 54 of the first piece 50 with respect to the tip portion 56 of the first piece of the valve seat 48. A portion of this surface 58 may also contact a portion of the control valve body 30 and the stop valve body 38 when the flow valve 10 is in the closed position. As such, the surfaces 54, 58 of the valve seat 40 provide for a guided flow of the steam in a flow direction through the flow valve 10.

By eliminating the flat portion 44 of the valve seat 48 in the embodiment of FIG. 2, and by providing the linear portions of the surfaces 54 and 58 of the valve seat 48 in a flow direction, a relatively smoother aerodynamic flow of steam may be achieved when the flow valve 10 is in the open position. That is, the amount of secondary flows and swirls may be reduced or even eliminated by this guided flow in a flow direction.

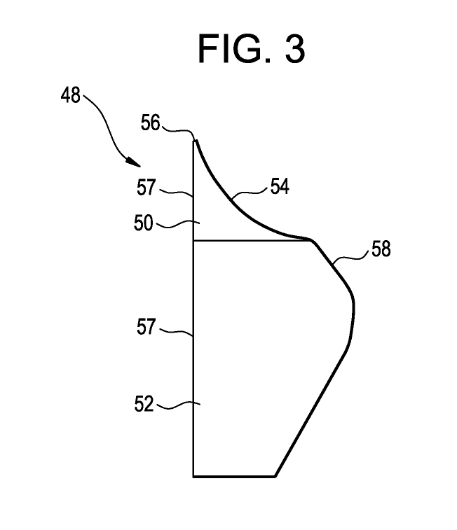

In FIG. 3 is a side view of the aerodynamic profile of a valve seat 48 located within the flow valve 10, according to another embodiment of the present invention. In this embodiment, the surface 54 may have a concave aerodynamic profile, while the surface 58 may be straight or linear. Similar to the embodiment of FIG. 2, the surfaces 54, 58 of the valve seat 40 provide for a guided flow of the steam in a flow direction through the flow valve 10. The concave profile of the surface 54 may begin in a flow direction after the tip portion 56, which may be pointed. Also, a portion of the surfaces 54 and 58 where they meet can be convex. Similar to the embodiment of FIG. 2, a relatively smoother aerodynamic flow of steam may be achieved when the flow valve 10 is in the open position with the embodiment of FIG. 3.

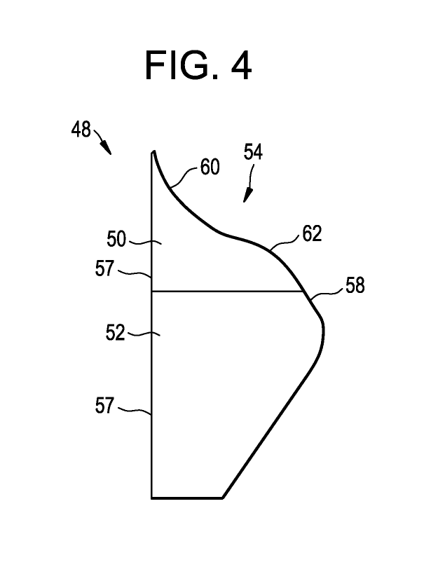

In FIG. 4 is a side view of the aerodynamic profile of a valve seat 48 located within the flow valve 10, according to yet another embodiment of the present invention. In this embodiment, the surface 54 may have a concave portion 60 near the tip portion 56 in a flow direction and may also have a convex portion 62 further away from the tip portion also in the flow direction. The concave profile of the surface 54 may begin after the tip portion 56, which may be pointed. A portion of the surface 58 may be straight or linear. Similar to the embodiments of FIGS. 2 and 3, a relatively smoother aerodynamic flow of steam may be achieved when the flow valve 10 is in the open position with the embodiment of FIG. 4. Also, similar to the embodiments of FIGS. 2 and 3, the surfaces 54, 58 of the valve seat 40 provide for a guided flow of the steam in a flow direction through the flow valve 10.

Embodiments of the present invention provide for a reduction in the amount of pressure drop across the flow valve 10. This leads to an increase in the efficiency in the steam turbine as well as relatively reduced vibrations and noise in the steam turbine. In addition, embodiments of the present invention provide for a relatively smoother aerodynamic path for the flow of steam inside the flow valve 10, thereby reducing viscous energy losses, which reduce the pressure drop across the flow valve 10. The relatively improved aerodynamic steam flow path across the flow valve 10 also reduces the pressure fluctuations in the flow valve 10. Further, embodiments of the present invention are not limited to use in steam valves; any type of valve may utilize embodiments of the present invention.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A flow valve, comprising:
a control valve having a movable body;
a stop valve having a movable body; and
a valve seat having a facing surface that contacts at least a portion of one of the control valve body or the stop valve body when the flow valve is in a closed position, the facing surface of the valve seat being configured to merge with a rear portion of the valve seat at a tip portion, the facing surface of the valve seat having an aerodynamic profile that provides for a guided flow in a flow direction through the flow valve.

2. The flow valve of claim 1, further comprising:
a casing;
an inlet in the casing through which a flow of steam flows into the flow valve; and
an outlet in the casing through which the flow of steam exits the flow valve when the flow valve is in an opened position.

3. The flow valve of claim 1, wherein the aerodynamic profile of the facing surface of the valve seat has a linear portion positioned after the tip portion in the flow direction.

4. The flow valve of claim 1, wherein the aerodynamic profile of the facing surface of the valve seat has a concave portion positioned after the tip portion in the flow direction.

5. The flow valve of claim 1, wherein the aerodynamic profile of the facing surface of the valve seat has a first portion that is concave and a second portion that is convex.

6. The flow valve of claim 5, wherein the aerodynamic profile of the facing surface of the valve seat has a straight portion positioned after the convex portion in the flow direction.

7. A flow valve, comprising:
an inlet through which a flow of steam flows into the flow valve;
an outlet through which the flow of steam exits the flow valve;
one of a control valve having a movable body or a stop valve having a movable body; and
a valve seat having a facing surface that contacts at least a portion of the one of the control valve body or the stop valve body when the flow valve is in a closed position, the facing surface of the valve seat being configured to merge with a rear portion of the valve seat at a tip portion, the facing surface of the valve seat having an aerodynamic profile that provides for a guided flow in a flow direction through the flow valve.

8. The flow valve of claim 7, wherein the one of a control valve having a movable body or a stop valve having a movable body has the corresponding body movable in a linear manner.

9. The flow valve of claim 7, wherein the aerodynamic profile of the facing surface of the valve seat has a linear portion positioned after the tip portion in the flow direction.

10. The flow valve of claim 7, wherein the aerodynamic profile of the facing surface of the valve seat has a concave portion positioned after the tip portion in the flow direction.

11. The flow valve of claim 7, wherein the aerodynamic profile of the facing surface of the valve seat has a first portion that is concave and a second portion that is convex.

12. The flow valve of claim 11, wherein the aerodynamic profile of the facing surface of the valve seat has a straight portion positioned after the convex portion in the flow direction.

13. A flow valve, comprising:
one of a control valve having a movable body or a stop valve having a movable body; and
a valve seat having a facing surface that contacts at least a portion of the one of the control valve body or the stop valve body when the flow valve is in a closed position, the facing surface of the valve seat being configured to merge with a rear portion of the valve seat at a tip portion, the facing surface of the valve seat having an aerodynamic profile that provides for a guided flow in a flow direction through the flow valve.

14. The flow valve of claim 13, wherein the aerodynamic profile of the facing surface of the valve seat has a linear portion positioned after the tip portion in the flow direction.

15. The flow valve of claim 13, wherein the aerodynamic profile of the facing surface of the valve seat has a concave portion positioned after the tip portion in the flow direction.

16. The flow valve of claim 13, wherein the aerodynamic profile of the facing surface of the valve seat has a first portion that is concave and a second portion that is convex.

17. The flow valve of claim 16, wherein the aerodynamic profile of the facing surface of the valve seat has a straight portion positioned after the convex portion in the flow direction.
